(19) United States
(12) Patent Application Publication
(10) Pub. No.: US 2002/0188709 A1
(43) Pub. Date: Dec. 12, 2002

(54) Console information server system and method

(75) Inventors: Montgomery C. McGraw, Spring, TX (US); Ramkrishna V. Prakash, Houston, TX (US); David P. Sharp, Houston, TX (US); Lazaro D. Perez, Houston, TX (US)

Correspondence Address: Baker Botts L.L.P., 2001 Ross Ave., Suite 600, Dallas, TX, 75201-2980, US

(73) Assignee: RLX Technologies, Inc.

(21) Appl. No.: 10/039,129

(22) Filed: Dec. 31, 2001

Related U.S. Application Data
(60) Provisional application No. 60/288,614, filed on May 4, 2001.

(51) Int. Cl. G06F 15/173

(52) U.S. Cl. 709/223

(57) ABSTRACT

A system and method for storing console information includes a plurality of computing devices, each computing device having a respective console, and a respective console interface. Each console interface may be operable to transmit console information associated with the respective console. A console server having a memory module may be coupled for communication with the plurality of computing devices. In a particular embodiment, the memory module may be operable to receive and store at least a portion of the console information.

### CROSS-REFERENCE TO RELATED APPLICATIONS

This application claims priority to U.S. provisional application U.S. Ser. No. 60/288,614 filed May 4, 2001.

This application is filed concurrently with the following commonly owned patent application entitled Console Information Storage System and Method (Attorney's Docket 067856.0234).

### TECHNICAL FIELD OF THE INVENTION

The present invention relates generally to server chassis communication systems and, more particularly, to a console information storage system and method.

### BACKGROUND OF THE INVENTION

Computing devices typically include a console that is used to control the computing device manually, correct errors, manually revise the contents of storage, and provide communications in other ways between an operator and the central processing unit and/or operating system. Console interfaces provoke an interface between the console of a computing device and the operator, or an external device.

A user interface (e.g., graphical user interface) may be coupled with the console interface to allow a local user to access the console of the computing device. The user interface may be used to provide a visible representation of information, whether in words, numbers, and/or drawings, on a user interface coupled with the computing device. User interfaces may include graphical user interfaces, monitors, keyboards, etc.

Console information generated by the console includes data, communications and/or signals communicated between the console of the computing device and an operator. Such information typically includes health, administrative, configuration and/or programming information, tools, commands, data and other information. Console information may also include data, signals, commands and other communications from a terminal unit to a console. For example, during startup of a personal computer, console information is displayed at a monitor coupled with the computing device. The console information includes health and configuration information regarding the particular computing device, its operating system, hardware and/or software components.

### SUMMARY OF THE INVENTION

The present invention provides a system and method for storing console information associated with the console of a computing device. In accordance with a particular embodiment of the present invention, console information from one or more computing devices is collected and/or stored at a memory module, and made available for future presentation to an operator of a console server which includes the memory module.

In one embodiment, a system for storing console information includes a plurality of computing devices, each computing device having a respective console, and a respective console interface. A console server may be coupled for communication with the plurality of computing device, the console server including a memory module. Each console interface is operable to transmit console information associated with the respective console. The memory module may be operable to receive and store at least a portion of the console information.

In accordance with a particular embodiment of the present invention, each console interface may be operable to transmit the console information to the console server periodically, at predetermined time intervals, and/or in response to a predefined event, circumstance, alert, or situation.

In accordance with another embodiment of the present invention, the console server may be operable to transmit requests to the plurality of computing devices to transfer at least a portion of the console information to the console server. The requests may be interrupt driven/on demand requests. The console server may be operable to transmit the requests in response to a predefined event.

In accordance with yet another embodiment, a method for storing console information associated with the plurality of computing devices, each computing device having a respective console, and a respective console interface, may include transmitting console information associated with the respective console, from the respective console interface. A console server may be coupled for communication with the plurality of computing devices, the console server including a memory module. The method may include receiving the console information at the memory module. In accordance with a particular embodiment, the console information is stored, at least temporarily, at the memory module.

Technical advantages of the present invention include a system and method for storing console information generated by the console of the computing device. By collecting, storing, manipulating, and/or presenting the console information to an operator, performance of the computing device and the associated consoles may be reviewed and analyzed in the future.

Another technical advantage of the present invention includes a system and method for collecting console information from a plurality of computing device, at a central console server. In this manner, a single computing device may be used to collect, store, and analyze console information from a plurality of computing devices. Storage of this information allows later presentation to an operator of the console server.

Other technical advantages will be readily apparent to one skilled in the art from the following figures, descriptions, and claims. Moreover, while specific advantages have been enumerated above, various embodiments may include all, some or none of the enumerated advantages.

### BRIEF DESCRIPTION OF THE DRAWINGS

For a more complete understanding of the present invention and its advantages, reference is now made to the following descriptions, taken in conjunction with the accompanying drawings, in which:

FIG. 1 illustrates a communication network including a server and a plurality of computing devices, incorporating various aspects of the present invention;

FIG. 2 illustrates a communication network including web server processing cards and network interface cards of a server chassis coupled for communication with various network components, in accordance with a particular embodiment of the present invention;

FIG. 3 illustrates the structure of a communication frame which may be used in accordance with a particular embodiment of the present invention;

FIG. 4 illustrates the structure of a communication frame which may be used in conjunction with a particular embodiment of the present invention;

FIG. 5 is a block diagram illustrating communication between a plurality of computing devices and a link board, in accordance with a particular embodiment of the present invention;

FIG. 6 illustrates a selection chart for mapping responsibility of a plurality of computing devices, in accordance with a particular embodiment of the present invention;

FIG. 7 is a block diagram illustrating inter and intra communication between a plurality of server chassis, in accordance with a particular embodiment of the present invention;

FIG. 8 illustrates bit field command messages, in accordance with a particular embodiment of the present invention;

FIG. 9 is a graphical representation illustrating the definition of the bit fields of FIG. 8, in accordance with a particular embodiment of the present invention; and

FIG. 10 is a graphical representation of bit fields of Acknowledge messages and their potential values, in accordance with a particular embodiment of the present invention.

### DETAILED DESCRIPTION OF THE INVENTION

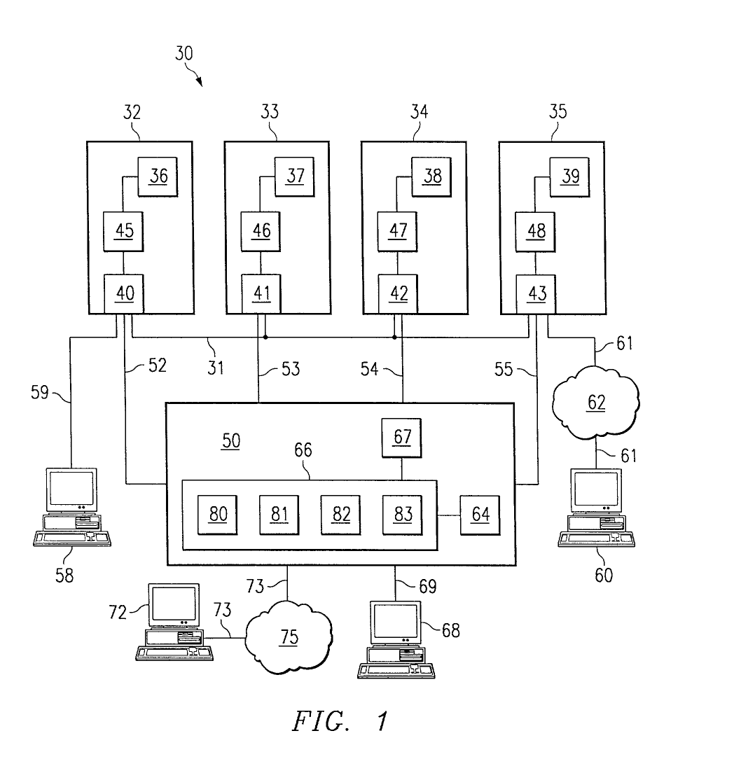

FIG. 1 is a schematic drawing illustrating a communication network 30 in accordance with a particular embodiment of the present invention. Network 30 includes a plurality of computing devices 32-35, each having an associated console 36-39, respectively, and console interface, 40-43, respectively. Memory modules 45-48 are coupled with consoles 36-39, respectively and are operable to store console information regarding computing devices 32-35, respectively. Each console interface 36-39 is coupled with a console server 50, using a plurality of communication links 45-48. In a particular embodiment of the present invention, console information regarding computing devices 32-35 is stored at memory modules 45-48, respectively, and/or communicated to console server 50. Accordingly, historical and/or real-time console information regarding computing devices 32-35 may be accessed by users of network 30. Furthermore, console server 50 provides access to computing devices 32-35 for communicating console information to and from computing devices 32-35 for monitoring, debugging, troubleshooting, maintenance, configuration and/or updates to terminal units 32-35.

Throughout this application, the term “console” includes the section of a computing device that is used to control the computing device manually, correct errors, manually revise the contents of storage, and provide communications in other ways between the operator and the central processing unit and/or operating system. Console interfaces 40-43 provide an interface between the console of each computing device and an operator and/or external device. A user interface may be coupled with the console interface to allow a local user to access the console of the computing device. For example, a console display 58 may be coupled with console interface 40. Console display 58 may include a visible representation of information, whether in words, numbers, and/or drawings, on a console screen coupled with computing device 32. In various embodiments of the present invention, console display 58 may include a user interface, graphical user interface, monitor, keyboard, mouse, personal computer and/or other computing devices.

Throughout this application, the term “console information” includes any data, communication, and/or signals communicated between the console of the computing device and an operator and/or user. Console information typically includes health, administrative, configuration and/or programming information, tools, commands, data and other information. Console information also includes data, signals, commands and other communications from a terminal unit to a console. During startup of a standard personal computer (PC), console information is displayed at a monitor coupled with the computing device. The console information includes health and configuration information regarding the particular computing device, it's operating system, hardware and/or software components. However, this information is not stored for later retrieval. Therefore, if a monitor is not coupled with the computing device, the console information cannot be viewed by a user. Furthermore, the user must view the console information in real time, as it is communicated from the computing device.

The manner in which console information is communicated and/or displayed to a user depends, at least in part, upon the particular software, hardware, and/or configuration of the computing device. For example, particular versions of the Microsoft Windows operating system are configured to display console information to a user of an IBM compatible PC via a video graphics array (VGA) interface. The Linux operating system, on the other hand, typically displays console information to a user in a serial manner. Regardless of the configuration of hardware and/or software associated with the computing device, the teachings of the present invention provide a method for storing, at least temporarily, this console information for later retrieval by a user.

In the illustrated embodiment, the console information may also be communicated to a server or another computing device coupled with the computing device of interest. For example, the console information regarding computing device 32 may be communicated to console server 50 and/or one or more of computing devices 33-35, which may be coupled with computing device 32. The server or attached computing device may also be configured to store the console information regarding one or more computing devices.

Memory module 45 includes hardware, software, and/or logic operable to read, record, buffer, store and/or communicate data and information between and among components internal and external to computing device 32. Since each computing device 32-35 includes similar components and function similarly, the operation and functionality of computing device 32 will be described in detail. However, it shall be recognized that all aspects and functionality of components of computing device 32 pertains to each computing device 33-35. For example, each memory module 46-48 is configured and functions similarly to memory module 45, with regard to their respective computing devices 33-35, respectively.

Console information associated with computing device 32 is communicated to console interface 36. Therefore, if console display 58 is coupled with console interface 40, a user can view the console information in “real-time” at the user interface. In accordance with a particular embodiment of the present invention, memory module 45 receives all console information generated by computing device 32 and stores the console information. Memory module 45 may comprise a buffer. Accordingly, memory module 45 would include a finite capacity. Therefore, data (e.g. console information) is stored until the buffer is full. When memory module 45 reaches its capacity, it begins writing over the oldest data currently in the buffer.

Console information regarding computing device 32, which is stored within memory module 45, may be accessed for further processing, by a user of network 30. For example, a user may couple a terminal unit 58 with computing device 32 and retrieve the console information stored at buffer 40. Console information stored within memory module 45 may be referred to as “historical console information.”

Throughout this application, the term “real-time” console information includes console information which is read and/or displayed as it is received from console 36. On the other hand, “historical console information” includes stored console information which is read, and stored by memory module 45, and/or any console information that is not communicated in real-time. Unless otherwise specified, the term console information shall mean real-time console information, historical console information, and/or any other information stored in memory module 45 (e.g., alerts), throughout this application. The term “memory module” may include all types of memory and storage media operable to store data, at least temporarily, for retrieval by a user and/or another computing device or server. In particular embodiments, memory module 45 may include random access memory (RAM), read only memory (ROM), dual in-line memory modules (DIMMs), registers, buffers, integrated circuits, volatile memory, micro-programmable devices, disk subsystems, and/or non-volatile memory. The term “module” includes software, hardware, and/or encoded logic operable to read, record, store, buffer, and/or communicate data and information between and among components of network 30.

Memory module 45 includes historical console information regarding computing device 32. In other words, memory module 45 includes console information collected (read) and stored over a period of time. Therefore, a user of terminal unit 58 may view console information communicated from console 36 before the occurrence of a specific event. For example, if computing device 32 experiences trouble, or crashes during operation, the user of terminal unit 58 may view console information communicated before, during and/or after the event. Similarly, the user of terminal unit 58 can review console information communicated by console 36 in the past, in order to determine the reaction of computing device 32 to any specific event or particular operating conditions and/or characteristics. This type of historical console information was not previously available to a user of a computing device. Instead, real-time console information was available to the computer operator if a user interface was coupled with computing device 32 and the console information was viewed by the operator in real-time, as it was communicated from console 36 to the user interface.

As illustrated in FIG. 1 with regard to computing device 35, a user may access real-time and/or historical console information regarding console 39, from a remote location. A terminal unit 60 is coupled with computing device 35 using communication link 61. Communication link 61 extends through communication network 62. Accordingly, a user may access console interface 43 from a remote location and view real time console information as it is received from console 39. The user may establish a two-way communication session in order to communicate with console 39. Alternatively, the user of terminal unit 60 may communicate with memory module 48 in order to retrieve historical console information stored within memory module 48. In alternative embodiments, terminal unit 60 may also be coupled for communication with one or more of computing devices 32-34 in order to monitor, review, and administer each computing device 32-35, remotely.

In accordance with another embodiment of the present invention, real-time console information generated by computing device 32 is communicated to console server 50 using communication link 52. Data and information received at console server 50, including real-time console information received from computing devices 32-35, may be viewed at a user interface 64 of console server 50. Console server 50 may be local to computing devices 32-35 (e.g. located on the same premises) or console server 50 may be located at a remote location, and/or coupled with computing devices 32-35 through a communication network.

Console server 50 includes a memory module 66 which is operable to store the console information received from computing device 32. Data and information stored in memory module 66, including historical console information received from computing devices 32-35 may be viewed at user interface 64. Therefore, a user of console server 50 may view historical console information regarding console 36 of computing device 32, by accessing memory module 66. Console server 50 also includes a console 67. Console server 50 may be configured to collect, read, buffer, store, process, communicate, and/or control its own console 67 and/or console information associated with console 67.

In another embodiment, for example if console server 50 does not include user interface 64, a terminal unit 68 may be used to view the console information received from computing device 32. Terminal unit 68 is coupled with console server 50 using communication link 69. Terminal unit 68 may be used to view real time console information received by console server 50 from computing device 32, in real time as it is received at console server 50. Alternatively, terminal unit 68 may be used to review historical console information regarding computing device 32, which is stored within memory 66.

A terminal unit 72 is coupled with console server 50 using a communication link 73. Communication link 73 extends through a communication network 75. Therefore, a user of terminal unit 72 may access console server 50 from a remote location, through network 75. The user of terminal unit 72 has access to real-time console information as it is communicated from console 36 to console server 50 and to terminal unit 72. The user of terminal unit 72 also has access to historical console information stored in any of memory modules 45-48 and/or memory module 66.

A plurality of terminal units, computing devices, user interfaces and servers, are disclosed throughout this specification. Any component included with one of these devices may also be included with any other, or all such devices. In alternative embodiments, terminal units, computing devices, user interfaces, monitors, and/or servers may include telephones, computers, personal computers, laptops, notebook computers, personal digital assistants, keyboards, monitors, memory modules, consoles, console interfaces, and any components associated therewith capable of data communication, and/or data processing internally, locally, and/or over a network. Communication links and communication networks disclosed herein may include any computer and/or communication network including, without limitation, the public switched telephone network (PSTN), the Internet, intranets, local area networks (LANs), wide area networks (WANs), or metropolitan area networks, for wireless or wireline communication incorporating twisted pair, cable, optical fiber, or other suitable wireline links, and/or radio frequency, microwave, infrared and/or other suitable wireless links.

In accordance with a particular embodiment of the present invention, memory module 66 may be configured to “poll” consoles 36-39 and/or memory modules 45-48 periodically, in order to collect and/or store real-time and/or historical console information associated with computing devices 32-35. In a particular embodiment, console server 50 communicates with one or more of computing devices 32-35, at predetermined time intervals, to collect real-time and/or historical console information. The console information collected by console server 50 may be stored at memory module 66 for retrieval by a network component coupled with console server 50. In other embodiments, console information may be communicated from computing devices 32-35 to console server 50 by interrupt driven/on-demand requests from either the computing devices or the console server. In other words, the console server may be configured to request console information from the computing devices in response to a particular event, circumstance, alert or situation. Similarly, the computing devices may be configured to transmit console information to the console server in response to a particular event, circumstance, alert or situation.

Memory module 66 includes a plurality of buffer modules 80-83, which communicate with computing devices 32-35, respectively. Therefore, console information collected by console server 50 regarding computing devices 32-35 may be partitioned, for convenient access to console information regarding a particular computing device, by users of console server 50, terminal unit 68 and/or terminal unit 72.

In accordance with another embodiment, computing devices 32, consoles 36-39 and/or memory modules 45-48 may be configured to transmit real-time and/or historical console information to console server 50 continuously, or at predetermined time intervals. There are many methods of communication between and among the various components of network 30. It will be recognized by those of ordinary skill in the art that any communication between components which result in real-time and/or historical console information being communicated to console server 50 and available for retrieval by a user of network 30 is included with aspects of the present invention.

Terminal units 68, 72 and/or console server 50 may be used to establish two way communication with computing devices 32-25, their respective consoles 36-39, and/or memory modules 45-49. Therefore, console 50, terminal unit 68, and/or terminal unit 72 may be used to collect and transmit information to any particular component of consoles 36-39. Accordingly, such users can perform operation, administration, troubleshooting, maintenance, debugging, and/or updates of consoles 36-39 from a remote location.

For example, a user of console server 50 may display, in a single communication session, console information regarding a single computing device. Alternatively, the user may display console information regarding all computing devices, simultaneously, in a single communication session. Furthermore, the user may select a group including two or more particular computing devices of computing devices 32-35 to communicate with in a single communication session.

This feature allows the user to review the console information associated with the group of computing devices to determine how each reacts/and or reacted to a particular situation. For example, if one or more servers crash, the user can review and/or compare the console information from each computing device that crashed, and/or perform maintenance, debugging, and/or repair on such terminal units simultaneously.

Console interface 40 is configured to broadcast communication sessions with terminal unit 58, and to console server 50, in real-time. Similarly, communication sessions between console server 50 and computing device 32 are communicated to terminal unit 58, in real time. Therefore, if a local user couples terminal unit 58 with console interface 40, and begins a communication session with console 36 and/or memory module 45, the communication session may be viewed, in real time, at user interface 64, terminal unit 68, and/or terminal unit 72. This allows two users to communicate with computing device 32 simultaneously, and each can view exactly what the other is doing and/or seeing at their respective user interface during their respective communication sessions. Accordingly, two users in remote locations from one another may cooperate to simultaneously communicate with and/or debug a particular computing device and/or group of computing devices.

Each computing device 32-35 of the illustrated embodiment is coupled with a communication bus 31. In the illustrated embodiment, bus 31 comprises an RS-485, two wire bus. In alternative embodiments, bus 31 may include RS-232, Ethernet, USB, and/or any communication link. Console information and other data, signals, and/or other information may be communicated between and among computing devices 32-35 using communication bus 31. Accordingly, one of computing devices 32-35 may be configured to function as the console server. If a computing device is selected to perform the functionality of console server 50, that computing device may include some or all of the components disclosed herein with regard to console server 50. Console information regarding one or more of computing devices 32-35 may be collected, and/or stored at a particular of computing devices 32-35.

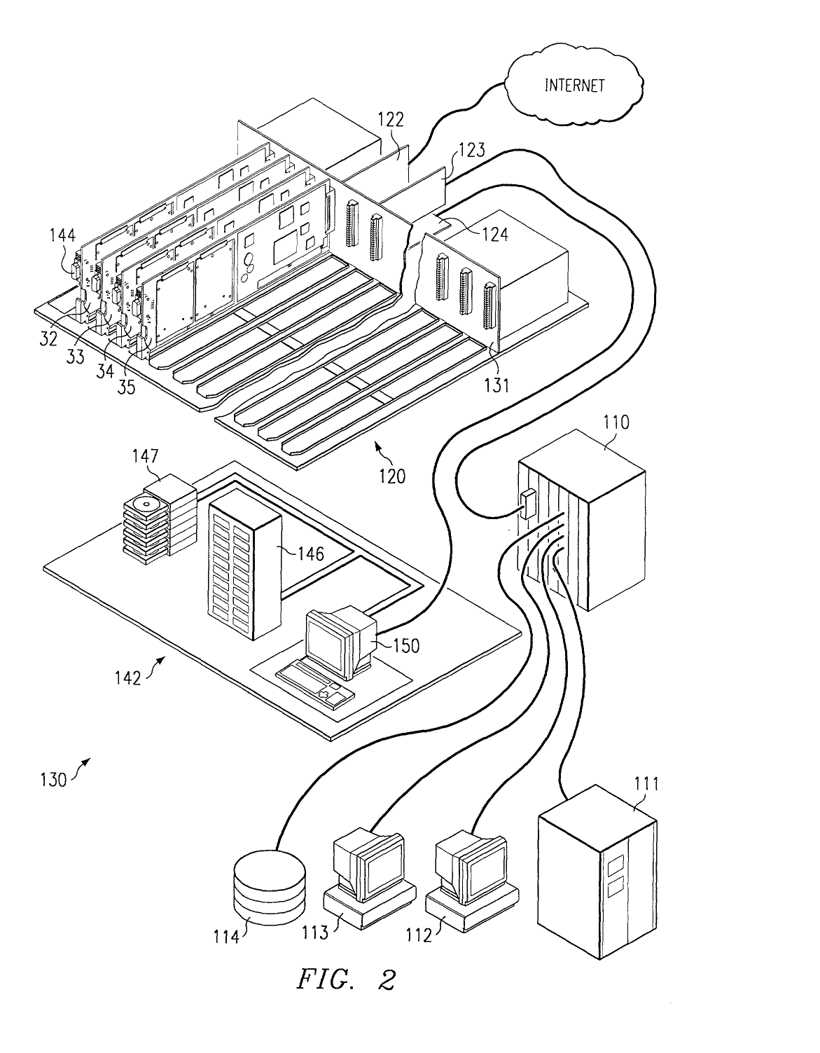

FIG. 2 illustrates a communication network 130, in accordance with a particular embodiment of the present invention. Network 130 includes a server chassis 120, with portions broken away for clarity, having the plurality of computing devices 32-35 coupled with a midplane 131. Midplane 131 includes communication bus 31 which couples server processing cards 32-25. In a particular embodiment, computing devices 32-35 include server processing cards.

A plurality of network interface cards 122-124 are coupled with midplane 131 and bus 31, and provide server processing cards 32-35 with access to a plurality of communication network components. For example, network interface card 122 is coupled with the Internet 140. Network interface card 123 couples server chassis 120 with another network of components 110-114. Network interface card 124 couples server processing cards 32-35, midplane 131 and network interface cards 122-123 with a management network 142.

Management network 142 includes console server 50 coupled with a plurality of network attached storage (NAS) devices 146-147. Management network 142 may be used for remote monitoring, configuration, debugging, maintenance, and/or management of server processing cards 32-35 and/or network interface cards 122-124.

In a particular embodiment, network interface cards 122-124 may include a “daughter” card(s) which comprise identical components and functionality to computing devices 32-35 and/or console server 50. Accordingly, all of the components and functionality of console server 50 may be attached directly to network interface card 124. Alternatively, all of the components of console server 50 may be attached directly to any one of computing devices 32-35. Therefore, a network operator may select the console server from among any computing device, network interface card, local terminal unit, and/or remote terminal unit.

As previously discussed, computing devices 32-35 may comprise server processing cards providing access to various communication networks, including the Internet. In a particular embodiment, a network administrator may distribute memory and processing power associated with server processing cards 32-35 to various customers. Such customers may use server processing cards 32-35 for storage of data, computing and processing of data, and/or web site hosting. The network operator may assign each customer to a different server processing card 32-35, or multiple customers may share one or more server processing cards 32-35.

In one embodiment, each computing device 32-35 may include at least two microprocessors, wherein one of the microprocessors is dedicated to perform the console memory function. Accordingly, the main CPU of each computing device will not be burdened with tasks of collecting, manipulating, storing and/or communicating console information. This approach provides transparency to the computing device's main CPU BIOS and OS, as opposed to performing console memory functions using the main CPU BIOS and OS. Furthermore, this type of architecture may be combined with the architecture of FIG. 7 in such a way that all console information is collected, manipulated, stored and/or communicated to other computing devices and/or servers without using the main CPU BIOS or OS.

In a particular embodiment, all of the components associated with console server 50 may be attached directly to one of server processing cards 32-35, allowing that particular card to assume console server responsibilities with regard to the other server processing cards, and network interface cards 122-124. If the network administrator selects server processing card 32, for example, to function as the console server for a given session, server processing card 32 will communicate with, and collect console information associated with server processing cards 33-35. This allows the network administrator to consolidate all console information with regard to server processing cards 32-35 upon a single server processing card. A local user may access server processing card 32 by coupling a terminal unit with a console interface 144. A user may also access console information regarding server processing cards 32-35 by coupling a terminal unit with network interface card 124. Similarly, a user may access console information regarding server processing cards 32-35 by remotely coupling a terminal unit with network interface card 124 and communicating the server processing card 32.

Two users may communicate with server processing card 32 regarding console information associated with server processing cards 32-35, simultaneously. In other words, if a user is coupled with console interface 144 locally, and communicating console information with server processing card 32, a user of a second console server, for example, console server 50, may view this communication session in its entirety, and participate. If the user at console server 50 communicates information with server processing card 32, the user coupled with console interface 144 can view this communication session, and participate. This feature provides simultaneous debugging of a server processing card or cards, wherein both users are local to chassis 120, one user is local and one user is remote, and/or both users are remote to server chassis 120.

All of the components and functionality associated with console server 50 may also be attached directly to network interface card 124. In this embodiment, network interface card 124 may be referred to as a management network interface card. Console information regarding server processing cards 32-35 may be communicated with management network interface card 124, and accessed by a user by coupling a terminal unit directly with management network interface card 124, locally, or remotely. All of the components, features, and functionality of console server 50 described herein may be included with one or more server processing cards 32-35 and/or one or more network interface cards 122-124.

In a particular embodiment, console server 50 communicates with server processing cards 32-35 and network interface cards 122-124, in order to determine which components are present. Console server 50 sends a message to each component asking that component to identify itself. Console server 50 then maintains a log of all components present during a session. Console server 50 periodically polls each of computing devices 32-35 and/or management network interface card 124, regarding console information. Console server 50 sends a message to the device commanding that device to forward console information stored at that device. Console server 50 collects the console information, and makes it available to a user of console server 50.

In another embodiment, all console information regarding server processing cards 32-35 and/or management interface card 124, are collected at a single device, for example, server processing card 32 or management network interface card 124. In this embodiment, console server 50 communicates with server processing card 32 or management network interface card 124 periodically to collect all console information regarding server processing cards 32-35 and/or management network interface card 124.

In a particular embodiment, a backup console server may be selected from among server processing cards 32-35, management network interface card 124, and/or console server 50. A backup console server may be configured to detect communication from the primary console server. If the backup console server does not detect communication from the primary console server for a predetermined amount of time, the backup server will execute an error message. The backup server will then either request permission from a network operator to assume console server responsibilities, and/or immediately begin performing console server responsibilities with regard to all components present. Alternatively, the backup console server may be configured to perform redundant console server responsibilities, in order to prevent loss of data due to failure of the primary console server. In this embodiment, the backup console server will collect console information regarding server processing cards 32-35 and/or management interface card 124, and include duplicate information to the primary console server.

Server processing cards which are not functioning as a primary or backup console server may be referred to as slave server processing cards, for example, server processing cards 33-35. Slave server processing cards are operable to buffer their own console information and provide data to the console server at predetermined intervals, and/or upon request of the console server.

In another embodiment, multiple server chassis may be provided, each having multiple server processing cards associated therewith. Multiple server chassis may be coupled using a communication bus, such as communication bus 31. The coupling between multiple server chassis may be accomplished by coupling the communication bus with network interface cards in each attached server chassis. In a particular embodiment, the communication bus may comprise an RS-485 bus. Accordingly, console server 50 may be operable to collect console information from a plurality of server processing cards distributed amongst a plurality of server chassis. In this manner, all console information regarding any number of server processing cards associated with any number of server chassis may be consolidated at console server 50.

Console server 50 may also be used to communicate with and/or configure, debug, and/or operate any of the server processing cards. This allows a user of console server 50 to establish a communication session with a plurality of server processing cards distributed amongst a plurality of server chassis during a single session. For example, the user could command console server 50 to display all console information regarding one, all or a specified group of server processing cards, in a single session. The user could also execute commands to all, or a subset of all server processing cards simultaneously. For example, in a particular embodiment, console server 50 may be used to reset all server processing cards, or a subset of server processing cards with a single command. The reset is operable to cause a reboot of each server processing card. The reboot may be from an operating system resident upon the particular server processing cards. Alternatively, console server 50 may be used to issue a command to all, or a subset of all server processing cards to boot from an attached element associated with a local area network (LAN). Console server 50 may also issue a command for a computing device “wake” (similar to wake on lan command). Similarly, console server 50 may issue a command to put the computing device to “sleep”.

Console server 50 may also monitor CPU and system health associated with components of computing devices 32-35. Accordingly, console server 50 provides for “out-of-band” management of computing devices 32-35.

Console server 50 may include security software which allows access to a particular server processing card or group of server processing cards to a single user only. The security may include a password input by the user at console server 50. Accordingly, console server 50 may be configured to allow different users access to different server processing cards. This feature prevents a user of one server processing card from gaining access to information upon another server processing card.

Console server 50 is also configured to allow a particular user to name their server processing cards, using alphanumeric letters. Communication with server processing cards is typically established with identification numbers. However, a user of console server 50 may name a particular server processing card or group of server processing cards. Therefore, a user who has access to three server processing cards 33-35 may name one of the servers “web server,” one of the servers “credit card database,” and one of the servers “storage database.” This is a user-friendly feature which allows a user to easily establish which server processing card they need access to perform a particular function or functions. An alphanumeric prompt may also be displayed while displaying console information from a particular computing device, which identifies the particular computing device. The prompt may be color coded to identify the state (communicating information, not communicating console information) and indicate which computing device is currently transferring information.

A user who has access to server processing cards 32-35 may request console server 50 to display all console information with regard to server processing cards 32-35 simultaneously upon a user interface of console 50. In this manner, the user can compare and contrast console information to determine how each server processing card is affected by a particular set of circumstances or operating conditions. Such conditions may include software updates, and/or intense processing loads experienced by the computing device(s). The user may also execute commands to server processing cards 32-35, simultaneously, over console server 50. Alternatively, the user may command console server 50 to display console information or allow communication with a single console associated with any of server processing cards 32-35. The user can execute commands at consoler server 50 which allow the user to “toggle” between various server processing cards. In other words, during a communication session with console 37 of server processing card 33, the user may interrupt that session without losing information, and toggle to a communication session with console 38 associated with server processing card 34. The user could also access console 39 associated with server processing card 35 without losing any information from the communication session with server processing cards 33 and 34.

Console server 50 provides a unified console for a user to access any computing device 32-35 that console server 50 serves. Accordingly, console server 50 provides an integrated interface that enables a user to use or access the interface from a variety of devices. Console server 50 provides flexibility to streamline access to multiple consoles. At least two modes of operation are available for console server 50: (i) command line mode; (ii) shell mode.

In the command line mode, a user who logs into console server 50 is able to run command line queries. This mode provides a quick and efficient manner to gather data from various computing devices 32-35. The privilege associated with access of information is based on log in privileges that the user is assigned as a result of logging into console server 50.

If a user issues a particular command, for example, “RLXCONSOLE,” the user enters the shell mode of console server 50. Options available to a user from the command line mode include the following:

1. rlxconsole-list(l)

rlxconsole-list (l)-chassis (cn)<chassis_number>

rlxconsole-list(l)-chassis(cn)<chassis_number>-slot(sn)<slot name>

rlxconsole-list(l)-group(g)<file_name>

When used with just the -list option, all the computing devices 32-35 console server 50 can allow the user to access are listed. When used in conjunction with the -chassis option, only the computing devices 32-35 in the specified chassis 120 are listed. When used with the additional option of -slot, only the particular computing devices 32-35 identified is listed. If the user does not have privileges to access either the chassis 120, the specified computing devices 32-35, an error notification message is posted.

The -group accompanied with a filename option used in conjunction with the -list option list all the computing devices 32-35 identified in the filename. The -group option allows the user to create a group of computing devices 32-35 on which the user would like certain operations performed. The file that contains the list of the computing devices 32-35 is a simple text file with each computing devices 32-35 identified by its chassis number and slot number separated by colons. Any text preceded by a “#” sign until a return character is deemed as a comment. If the user does not have privilege to access a particular computing devices 32-35 listed in the group file, an error notification is posted.

2. rlxconsole-status(s)

rlxconsole-status(s)-chassis(cn)<chassis_number>

rlxconsole-status(s)-chassis(cn)<chassis_number>-slot (sn)<slot_name>

rlxconsole-status(s)-group(g)<file_name>

This option lists the status of all the computing devices 32-35 that the console server 50 can allow the user to access. The status information indicates which of the possible computing devices 32-35 are really capable of being accessed. When used in conjunction with the -chassis option, only the status of computing devices 32-35 in the specified chassis are listed. When used with the additional option of -slot, the status of only the particular computing device 32-35 identified is listed. If the user does not have privileges to access either the chassis 50 or the specified computing device 32-35, an error notification message is posted. The status option can also be used in conjunction with the -group option.

3. rlxconsole-backup(b)

rlxconsole-backup(b)-chassis(cn)<chassis_number>-slot (sn)<slot_name>

This option when used by itself identifies the currently designated backup console server. When used in conjunction with the additional options—chassis <chassis_number>-slot<slot_name>to identify a particular computing device 32-35, it results in the specified computing device 32-35 being designated as the new backup console server and reassignment of the previous backup console server to be just a computing device 32-35. Only the “root” level user has privileges to execute this command.

4. rlxconsole

rlxconsole-chassis(cn)<chassis_number>-slot(sn) <slot_number>

rlxconsole-chassis (cn)<chassis_number>

rlxconsole-group (g)<filename>

The rlxconsole command when issued by itself without any options, results in invoking of the rlxconsole shell, which will be discussed later. When used with additional options -chassis and -slot to identify a particular computing device 32-35, a console session is established with the computing device 32-35 within the rlxconsole shell. If just the -chassis option is used, then console sessions to each of the computing devices 32-35 accessible to the user is made within the rlxconsole shell. However, only the computing device 32-35 with the lowest slot ID is displayed. If the user wished to access the console server 50 of any of the other computing devices 32-35 within the chassis to which the console server 50 made a connection, the user would have to use rlxconsole shell command “rlxtoggle.” The shell commands are discussed in the next section. If the user used rlxconsole with the -group options, computing devices 32-35 will establish console sessions to each of the computing devices 32-35 mentioned in <filename> that is accessible to the user. Here again, the connection is made within the rlxconsole shell and only the computing devices 32-35 with lowest Chassis:Slot ID combination is displayed. Here again, using the rlxconsole shell command, the user can access other console session.

5. rlxconsole-user(u)<username>

rlxconsole-user(u)<username>-passwd(p)<password>

rlxconsole-superuser(su)<password>

This option allows the user to change his access profile to that of the user specified by the username. If the specified username has privileges that are lower than the one the user used to login, a password is not required. However, if the specified username has privileges that are higher than the one the user used to login, then a password is required. When used with the option -superuser, it is assumed that user wants “root” level privileges. To assume superuser level privileges, the user must already be running in root level privilege mode on the system before evoking these privileges within rlxconsole. This option can be used in conjunction with any of the command line options discussed above.

The rlxconsole shell allows a user to engage in prolonged console sessions with computing devices 32-35 in a concurrent manner. A user can enter the rlxconsole in one of two ways described above. The first method is by executing the rlxconsole as a command line operation. The second is by evoking a command line of the rlxconsole with the option of listing one or more computing devices 32-35. Once inside the rlxconsole shell, only shell commands are valid. These shell commands that a user can execute within the rlxconsole shell are described below:

1. rlxconnect-chassis(cn)<chassis_number>-slot(sn) <slot_number>

rlxconnect-chassis(cn)<chassis_number>

rlxconnect-group(gn)<filename>

This command is similar to the rlxconsole command line command, but used within the rlxconsole shell. rlxconsole command does not work within the shell. The options allowed for rlxconnect are similar to the rlxconsole line command used with the same options (see item 4 cases second through fourth). Here again, the options -chassis<chassis_number>-slot<slot_number>refers to a particular computing device 32-35 in the chassis. If the user supplied just the option -chassis<chassis_number>, all the computing devices 32-35 in the chassis that the user has access to are also connected. Similarly, using the -group<filename>option, all the computing devices 32-35 listed in the file are connected. Note that only the computing devices 32-35 that the user has permission to access are connected. Also, if any error occurs, an error notification is provided.

2. rlxtoggle

rlxtogglet-chassis(cn)<chassis_number>-slot (sn) <slot_number>

rlxtoggle-chassis(cn)<chassis_number>

rlxtoggle-slot (sn)<slot_number>

This command allows the user to toggle between the current console connections to a pre-established console connection with a computing device 32-35. When rlxtoggle command is issued, the computing device 32-35 with the next higher chassis ID:slot ID combination, connection, is consoled into. A particular computing device 32-35 can be specified using the -chassis(cn)<chassis_number>-slot(sn)<slot_number>option. If just the -chassis (cn)<chassis_number>is issued, then it assumed that the user would like to access the console of the computing device 32-35 with the current slot ID, but with the specified chassis ID. Likewise, if just the -slot(sn)<slot_number>option is provided, then it is assumed that the user would like to console into the computing devices 32-35 with the same chassis ID, but with the specified slot ID. rlxtoggle can enable the user to console into established connection. If an user tries to toggle into computing device 32-35 who has not been connected to, then an error notification is generated.

3. rlxexit

rlxexit-all

rlxexit-chassis(cn)<chassis_number>-slot(sn) <slot_number>

rlxexit-chassis(cn)<chassis_number>

rlxexit-slot(sn)<slot_number>

This shell command allows a user to close a console connection made to a computing device 32-35. When rlxexit is specified without any option, then the current console connection that the user is viewing is closed. If no console connection is in progress, then this causes the user to exit from rlxconsole shell. When this command is used with the -all option, all the console connections currently established are closed, and the user exits from the console shell. If a user would like to close the connection to a particular computing device 32-35, then the user can specify this using the -chassis cn)<chassis_number>-slot(sn)<slot_number>options. If the user uses either the -chassis(cn)<chassis_number>or the -slot(sn)<slot_number>option with the rlxexit shall command, then connection to all the computing devices 32-35 with specified chassis ID or slot ID are terminated respectively.

4. rlxbackup

rlxbackup-chassis(cn)<chassis_number>-slot(sn)<slot_name>

This command, when used without any option lists the current backup console server. When used with the -chassis(cn)<chassis_number>-slot(sn)<slot_name>causes the identified computing devices 32-35 to be designated as the new backup console server. Note that this command will work only if the user has “root” privileges.

5. rlxlist

rlxlist-chassis(cn)<chassis_number>-slot(sn)<slot_name>

rlxlist-chassis(cn)<chassis_number>

rlxlist-slot(sn)<slot_name>

This command allows the user to list all the computing devices 32-35 that the user has access to. The additional options allow the user to specify a particular computing device 32-35 in a chassis with a similar slot ID respectively. This command operates in a similar manner as the rlxconsole-list command line version.

6. rlxstatus

rlxstatus-chassis(cn)<chassis_number>-slot(sn)<slot_name>

rlxstatus-chassis (cn)<chassis_number>

rlxstatus-slot (sn)<slot_name>

This command allows the user to query the status of all the computing devices 32-35 that the user has access to. The additional options allow the user to specify a particular computing device 32-35 or computing devices 32-35 in a chassis or with the similar slot ID respectively. This command operates in a similar manner as the rlxconsole-status command line version.

The communication of console and other information between computing devices 32-35 and/or console server 50 of the present invention, employs a console server protocol which is built on top of the open standard ModBus protocol, which defines a multi-dash drop protocol RS232, RS422, or RS485 over a variety of media. Such media may include, without limitation, fiber, radio, cellular, etc. In a particular embodiment of the present invention, the console server protocol is used over the RS485 physical layer.

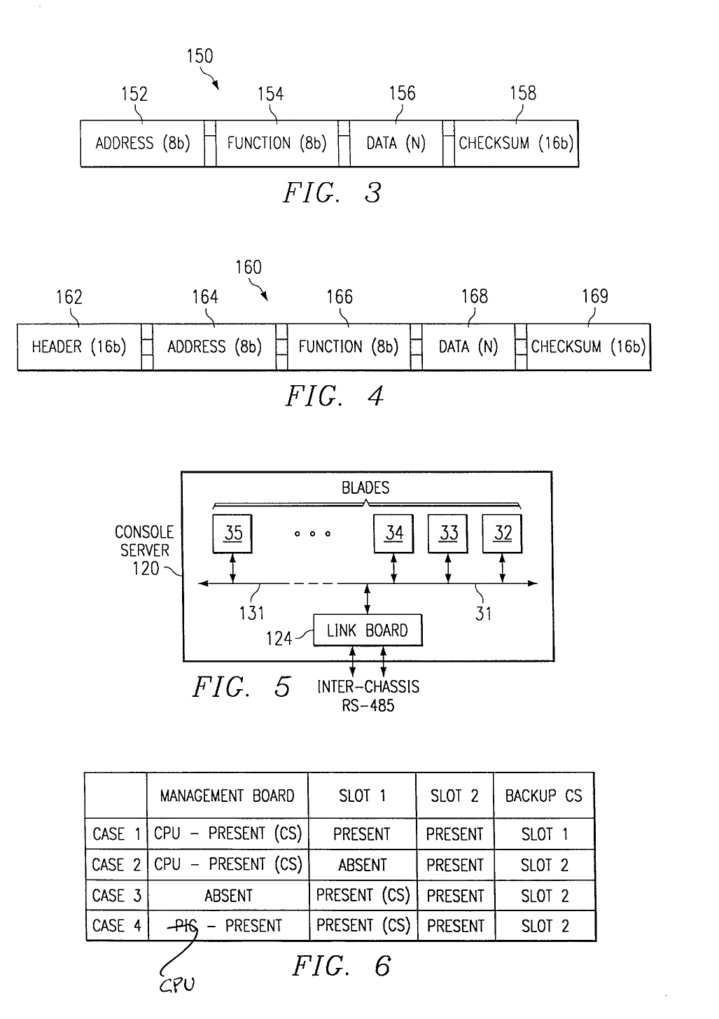

FIGS. 3-9 and the description below illustrate particular embodiments which incorporate some aspects of the present invention.

The framing of the ModBus protocol is described in more detail, with regard to FIG. 3. FIG. 3 illustrates the basic structure of a ModBus frame 150. The ModBus packet format comprises an address header 152 followed by a function 154, which in turn is followed by data 156. A two-byte CRC algorithm is used to error-check this packet, and this is appending to each of the packets. The ModBus protocol comprises an eight-bit address field within address header 152, followed by an eight-bit function field within function 154. The data field within data 156 that follows the function field is of variable length. The ModBus frame ends with a sixteen-bit CRC 158 that is calculated over the entire packet. When this packet is transmitted over the RS485 bus, silent periods before and after the transfer are used as the delimiters for transfer.

The framing of the console server protocol is discussed in more detail with regard to FIG. 4. Modifications have been made to the ModBus protocol to facilitate additional flexibility and ease the processing burden on computing devices 32-35 that are not involved in a particular communication session. A delimiter field has been added to minimize overhead associated with tracking of communication periods. The start delimiter is FFFF and silent periods function as the end delimiter. Accordingly, there are no FFFF patterns in other packets. The total number of data bytes transferred in a packet of the illustrated embodiment will not exceed 64K-1 bytes. Adapting this delimiter enables the computing devices that are not involved in communication to passively monitor for a start delimiter pattern to resynchronize communication.

A typical frame of data 160 that is transferred using the console server protocol follows the general format graphically illustrated in FIG. 4. Header field 162 comprises the start delimiter FFFF. Address field 164 is a slot-identifier field that identifies the computer device 32-35 that the console server 50 is communicating with. The function field 166 denotes either a message from a console server 50 to a computing device 32-35, or a response from computing device 32-35 to console server 50. Data field 168 is optional and is dependent on the function field 166 type. The interpretation of data field 168 is dependent on the function field 166. The last field is a sixteen-bit CRC 169, which is calculated over the entire packet. The physical protocol over which the data will be transferred in the illustrated embodiment, comprises the RS485 protocol. In this embodiment, the RS485 protocol requires the transfers of one byte of data at a time. Each byte transfer using the RS485 protocol begins with a start bit followed by a byte of data, a paradity bit and a stop.

An overview of the console server behavior is discussed in more detail with regard to FIG. 5. FIG. 5 includes console server 50, which is capable of communicating with computing devices 32-35 and the link computing device in its chassis to gather data as well as to determine the states of each computing device. The link card in a chassis is the computing device which communicates with link cards and/or computing devices of other chassis to collect information from computing devices within other chassis. In a particular embodiment, the link card comprises network interface card 124 of FIG. 2. The link card entity is a bridge between multiple chassis and is involved in proxy of commands on behalf of console server 50. This enables console server 50 to provide integrated console services across multiple chassis.

A slave blade refers to a computing device that communicates with console server 50 when it is communicated with by console server 50. The slave blade may be any computing device 32-35 that is not acting as console server 50. If designated as a backup console server, the slave blade is capable of monitoring the activity of console server 50, and capable of taking over in situations when console server 50 is not functional. For example, if the slave blade does not receive communication from console server 50 for a predetermined period, the slave blade may be configured to take over the function of console server 50. FIG. 5 illustrates a schematic view of these components and associated interconnection paths.

Console server 50 is responsible for collecting console information and data from the slave blades. The slave blades in turn respond to commands issued by console server 50 to transfer data to console server 50. Console server 50 is also responsible for sending console data to the appropriate slave blades.

The typical sequence of messages of the protocol that console server 50 uses to communicate with the slave blades may follow the following sequence: (i) console server 50 sends a message; (ii) slave blade receives the message; (iii) slave blade sends a response; and (iv) console server receives a response.

In a particular embodiment of the present invention, the console server may support the following features. The console server may keep a history buffer of the console messages from all the computing devices 32-35 that it collects data from. The console server may communicate console data to and from all the monitor computing devices 32-35. When a session is initiated to a computing device 32-35, all the buffer data stored by console server 50 for that computing device will be presented. On repeated querying of a computer device 32-35, only data not presented previously is displayed.

The operation of the console server may include at least two phases, the configuration phase and the operation phase. In the configuration phase, console server 50 determines the number of active computing devices 32-35 in its chassis, and determines the number of active chassis in its neighborhood. The neighborhood of a particular chassis includes all other chassis which include computing devices under the monitoring or control of the console server. In one embodiment, this includes some or all of the computing devices within a given chassis. In the operation phase, the console server collects data from each of the computing devices 32-35, which the console server detected during the configuration phase. The console server also transmits console data to the appropriate computing devices 32-35. Periodically, the console server collects data from chassis within the console server's neighborhood over an inter-chassis RS485 bus.

The slave blade is a slave to the console server in its operation; hence, its default mode is to listen to traffic on the local RS485 bus. If the slave blade detects, or hears a command with the slot identifier that matches the chassis and slot number of the slave blade, then a response to the query of console server 50. After responding to the query, it goes back to its default listen mode.

During the configuration phase, in order to detect computing devices 32-25 in a chassis, the console server sends the “Identify <Slot-Identifier>” command on the local RS-485 bus and listens for a response. The Slot-Identifier assumes two values based on whether the message is intra-chassis or inter-chassis. For intra-chassis communication, the Slot-Identifier field assumes the Slot Number (8b) of the computing device that the console server is communicating with. For inter-chassis communication, the Slot-Identifier field assumes the Slot Number (8b) of the Link board. The Slot number is the value of the slot wherein the computing device is plugged. The Link board (when incorporated) assumes the unique slot number F7.

The Slave Blade at the slot indicated by the Slot-Identifier on receiving the Identify message replies with the “Acknowledge <Data>” command. The Data field associated with this response comprises of the following information of the blade:

| | |
|---|---|
| <Number of Bytes> | |
| <Chassis Number (8b)> | |
| <Slot Number (8b)> | |
| <Not participating (8b)> | |
| <PIC code version (16b) | Format: Ax(4b)x(4b).x(4b)> |
| <BIOS code version (16b)² | Format: Bx(4b)x(4b).x(4b)> |
| <Linux driver version (16b) | Format: Cx(4b)x(4b).x(4b)> |
| <Windows driver version (16b) | Format: Dx(4b)x(4b).x(4b)> |
| <Console Server version (16b) | Format: 1x(4b)x(4b).x(4b)> |

After supplying this data, the Slave Blade goes back to its listen mode. The console server on receiving this answer makes an entry in the “Configuration Table” and continues to send the Identify command with the next Slot-Identifier. If the console server does not hear from the Slave Blade in a pre-determined time interval, it resends the “Identify <Slot-Identifier>” message on the RS-485 bus. If the console server does not hear from a Slave Blade even on its third request, it concludes that there is no Slave Blade in the slot represented by the Slot-Identifier and moves on to query the next slot. It then also updates the Configuration Table indicating board-not present in the slot.

In accordance with a particular embodiment of the present invention, computing devices (e.g. Slave blades) in neighboring chassis are detected using an embedded microprocessor based, inter-chassis communication board. On detecting an Inter-chassis Link Board on its chassis, the console server sends the Identify_Interchassis command on the local RS-485 bus. After sending this command, the console server waits for a response. The Link Board is the only card that acts on this command. On sensing the Identify_Interchassis command on the local RS-485 bus, the Link Board forwards the request to the inter-chassis RS-485 bus along the out_port and appends a <Data> field to the command. The Data in the forwarded message comprises a <number-of-chassis> field and <chassis ID> field which is the chassis ID. The subsequent Inter-chassis Link board that receives this command in turn forwards it further on but prior to that it increments the <number-of-chassis> field and appends its chassis ID to <chassis ID> field. As this messages cycles through the chassis, it finally reaches the Inter-chassis Link board on the chassis with console server. The Link Board in this Chassis then forwards the aggregated response to the console server over the local RS-485 bus.

If the console server does not receive an Identify_Interchassis response in pre-determined time interval, it resends the Identify_Interchassis command again. If it does not receive a reply even on its third attempt, it concludes that no chassis are present in its neighborhood and updates the Configuration table to indicate this. Thus, the Configuration Phase results in either the creation or the updating of the Configuration Table, which logs the boards present in its chassis and the presence of an additional neighboring chassis.

During the operation phase, communication between computing devices (e.g. server blades) within a chassis is accomplished as follows. In order to detect the states of the slave blade(s), the console server sends a “Status<Slot-Identifier>” command on the RS-485 bus and listens for “Acknowledge<Slot-Identifier>” response from a Slave Blade. The Slot-Identifier field in the Acknowledge response is slot number of the responding Slave Blade. The Acknowledge response comprises Status fields that indicates some or all of the following: Slave Blade has data; buffer overrun; buffer data has passed ¾ capacity; error was detected in the request; CPU health; multiple Byte transfer; NAK which implies the Console to retry later; function not supported; and/or extended Acknowledge.

There are two formats for the Acknowledge messages that result as a response to the Status message. The short format comprises of a one-byte Acknowledge response. The long format comprises of a two-byte Acknowledge response. Whenever the Slave blade or a console server detects an error in the message issued to them, they respond back with the Error bit set in the “Acknowledge” response. The setting or clearings of the bit fields of the Acknowledge response are discussed later in more detail.

Whenever the console server determines a Server Blade has console data and wants to get it from a Slave Blade, it sends a “Transit<Slot-Identifier>” command on the RS-485 bus and listens for a response. The Slave Blade, whose slot number matches the Slot-Identifier, on receiving this Transmit command starts to reply. The Slave Blade replies with “Acknowledge<Slot-Identifier><Data>” command followed by data. The first two bytes of the data field indicate the number of data bytes that the Slave Blade intends on transmitting, followed by the actual data. If the Slave Blade has no data to transmit, it sets the first two bytes to zeros, indicating it intends to send no data. The Slot-Identifier indicates the slot number of the Slave Blade. The console server on successfully receiving all the bytes sent by the Slave blade sends an “Acknowledge” message with the Error bit cleared. The console server then proceeds to request data from the next Slave Blade as indicated by the Configuration Table. If, on the other hand, the console server did not receive the bytes successfully, it sends the “Acknowledge” message with the Error bit set. The Slave Blade, on receiving this message, resends the entire data. If the console server does not receive the data correctly from the Slave Blade in three tries, it logs an error.

If the console server has Console data that it needs to send to the Server Blade, it sends a “Receive <Slot-Identifier><Data.” command on the RS-485 bus and listens for an acknowledgement. The Slave Blade on successfully receiving all the bytes sent by the console server sends the “Acknowledge” message with Error bit cleared. If, on the other hand, the Slave Blade did not receive the bytes successfully, it sends the “Acknowledge” message with the Error bit set. The console server on receiving this message resends the entire data.

The console server and the Serve Blades may use the same command sequence as described above for inter-chassis communication. The Inter-chassis Link Board is responsible for forwarding the queries across the inter-chassis RS-485 bus and collects the responses from the inter-chassis RS-485 bus and conveys it on the local RS-485 bus to the console server.

The Slave Blade performs the functions described below:

Detects and identifies itself (Slot and Chassis ID); determines if it is designated as a backup console server; and/or responds to command issued to it by the console server. In the case that the Slave Blade has also been designated as a backup console server, it is responsible for the detection of the dysfunction of the console server and is capable of taking over the console server function.

The steps that the Slave Blade would go through are as follows:

(i) On power up, the slave blade determines its identity in the chassis along with details regarding the version of software and firmware running on it. The identity is defined as the Chassis and the Slot-Number that it is in. If it determines that its Slot number is either 1 or 2 and that it's “Master bit” has not been set, it concludes that it has the potential of becoming the backup console server; (ii) if a Slave Blade is not a backup console server, then it waits for commands from the console server and responds with appropriate replies; and (iii) if the Slave Blade is also a backup console server, then in addition to replying to commands from the console server, it monitors for traffic on the local RS-485 bus. If it notices there is no activity on the Local RS-485 bus, it concludes that console server is non-operational and it performs the recovery procedure that it has been programmed to execute.

Two recovery procedures for a backup console server include manual recovery and automated recovery. For manual recovery, the backup console server on detection of a non-functional primary console server, notifies the NOC.

In the automated recovery mode, the Slave Blade, which is deemed as the backup console server, automatically takes over the functionality of the console server and activates console server software applications on its blade. Thus, the backup console server assumes the full functionality of the defunct console server.

Assignment of the console server may be done manually or automatically. In the manual mode, the operator is responsible for manually assigning which of the Slave Blades will be responsible for being the backup console server.

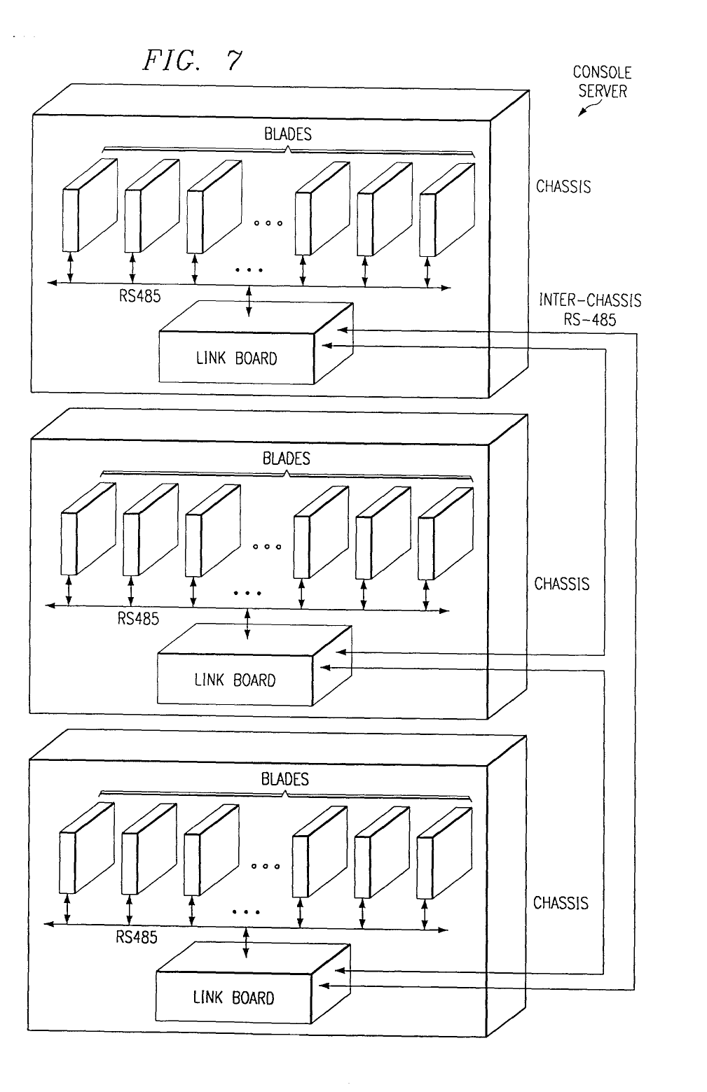

In accordance with a particular embodiment of the present invention, Server Blades in Slot 1 and Slot 2, and the Inter-chassis communication Board, or link board, are capable of assuming the backup console functionality. In the automatic assignment mode, one order of preference is as listed in FIG. 6.

During the initial configuration of a Slave Blade as a backup console server, it needs to be provided with an address for notification. This notification could be via SNMP or via email. The information that is sent in the notification is the IP address of the backup console server that has assumed the functionality of the console server or has detected the dysfunction of the console server.

FIG. 6 outlines the overall flowchart that illustrates the functioning of the console server. The console server software continuously performs the configuration and the operation phases. The configuration phases are performed not as frequently as the operation phase. The configuration phase is involved in identifying the presence and status of the board. Since only the blade in Slot 1 of the chassis is capable of executing command bus command, the Server Blade in Slot 1 may be a good candidate for the console server function.

If the console server blade is in Slot 1, then it can detect the presence of a Slave board via side band signaling over the command bus. The console server then runs the configuration phase querying each of the Slave Boards their status. The console server accepts one of the following three responses from each Blade that has been detected to be present:

(i) Board present and functioning: This implies that Board is present and is capable of redirecting Console traffic; (ii) Board present and not participating: This implies that the Board is present and has chosen not to participate in the redirection of Console traffic; and (iii) Board present and not functioning: This implies that the Board is present and the console server is not receiving any responses back. Only in console server is Slot 1 capable of differentiating this from Board not present as it capable of using the Command bus to determine board presence.

If the console server does not hear a Server Blade, it assumes that the blade is not functional and performs the appropriate notification.

A Server Blade can be set to mirror or not to mirror its console information down the RS-485 bus. This is achieved via setting a bit in NVRAM.

The inter-chassis communication board (e.g. link board) is an optional feature that allows the cascading of multiple chassis such that a single console server can serve multiple chassis. The Inter-chassis communication Blade also enables the backup console server to live in any other chassis. A bi-directional daisy chain approach has been adopted to ensure that enables the detection of link failures. FIG. 7 schematically illustrates a particular embodiment of the design.

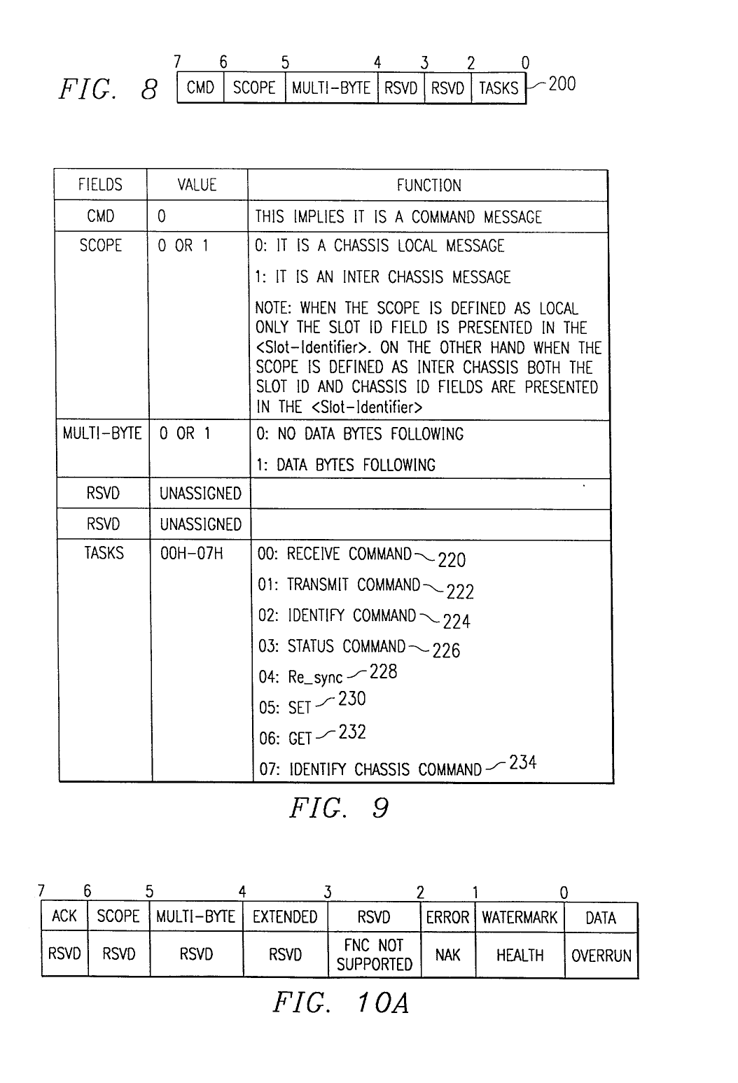

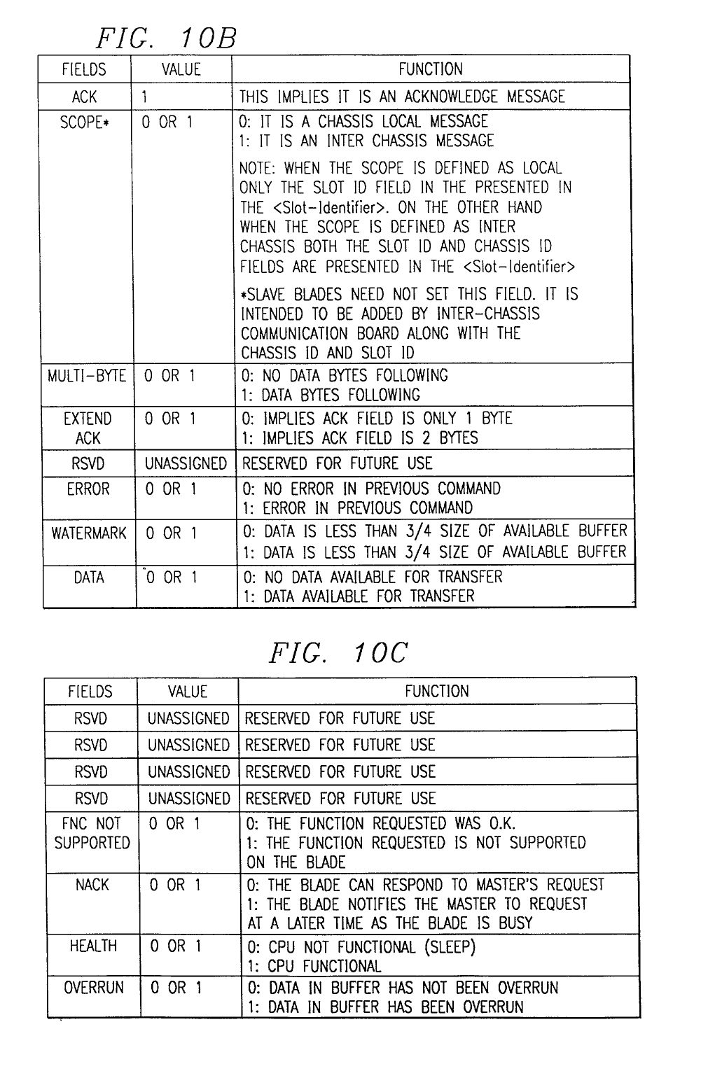

Two types of message formats are available for communications between the console server and a particular computing device (e.g. Slave Blade), including command messages and Acknowledge messages. All of the messages may be inter- or intra-chassis. A scope bit 200 determines whether the message is inter- or intra-chassis. For inter-chassis commands, the two bytes that immediately follow the function field denote Chassis ID and Slot ID, respectively. FIG. 8 illustrates the bit fields of command messages. The definition of each bit field is described in FIG. 9.

Receive command 220 is issued by the console server to send console data to the Slave Blade. This usually results in the Slave Blade receiving data from the console server. On successful receipt of the data, the Slave Blade responds using an Acknowledge command. The format that the console server uses to send data is to initially send two bytes that state the number of bytes of data that it intends to transmit, followed by the data.

Transmit command 222 is issued by the console server to request the Slave Blade to transmit data. This usually results in the Slave Blade sending data to the console server using the Acknowledge command. The format that the Slave Blade uses to convey data is to first send two bytes that state the number of bytes of data that the Slave Blade intends to transmit, followed by the data. If the Slave Blade has no data, it sends two bytes with all bits set to zero, indicating that it has no data to send.

Identify command 224 is issued by the Console Serve to request a Slave Blade to identify its presence. The typical response from the Slave Blade is an Acknowledge command.

Status command 226 is issued by the console server to request the Slave Blade to transmit its status. This typically results in the Slave Blade responding using the Acknowledge command to indicate whether or not it has any data available or other status information that may be relevant.

Re_sync command 228 is issued by the console server to request that all the Slave Blades resynchronize. This usually results in the Slave Blade performing an internal resynchronization operation. No response to the console server is expected to the Slave Blades.

Set command 230 is issued by the console server to request that the Slave Blade set certain fields in its internal registers. This usually results in the Slave Blade setting the bits and informing the console server via an Acknowledge command. If the Slave Blade is unable to set the registers, it responds back with the error bit set in the Acknowledge.

Get command is issued by the console server to request the Slave Blade to transmit certain fields in the internal registers of the Slave Blade, to the console server. This typically results in the Slave Blade sending the bits to the console server via an Acknowledge command. If the Slave Blade is unable to get the registers, it responds to the console server with an error bit set in the Acknowledge.

The bit fields of Acknowledge messages and their potential values and meanings are illustrated in FIG. 10. Acknowledge messages may be sent by the console server or a Slave Blade. The Slave Blade sends this message as a response to identify, transmit, status, receive, get or set commands that are sent by the console server. In the case where a Slave Blade is responding to a transmit, identify and get command, the Acknowledge message sent by the Slave Blade also contains data.

The console server also sends Acknowledge messages as a response to receiving data bytes from a Slave Blade. The Slave Blade sends this message as a response to a receive, status or set command sent by the console server. In response to such messages, only an Acknowledge command is sent. The Acknowledge message can be either a single or two byte long message depending on the information that needs to be conveyed. Acknowledge messages are intended to follow as a consequence of command messages. They are in all three types of Acknowledge messages.

Although the present invention has been described in several embodiments, a myriad of changes and modifications may be suggested to one skilled in the art, and it is intended that the present invention encompass such changes and modifications as fall within the scope of the present appended claims.

what is claimed is:

1. A system, comprising:
a plurality of computing devices, each computing device having a respective console, and a respective console interface;
each console interface being operable to transmit console information associated with the respective console;
a console server coupled for communication with the plurality of computing devices, the console server including a memory module; and
wherein the memory module is operable to receive and store at least a portion of the console information.

2. The system of claim 1, wherein each console interface is operable to transmit the console information to the console server, periodically.

3. The system of claim 2, wherein the console information is transmitted to the console server at predetermined time intervals.

4. The system of claim 2, wherein the console information is transmitted to the console server in response to a predefined event, circumstance, alert or situation.

5. The system of claim 1, wherein the console server is operable to transmit requests to the plurality of computing devices to transfer at least a portion of the console information to the console server.

6. The system of claim 5, wherein the requests comprise interrupt driven/on demand requests.

7. The system of claim 5, wherein the console server is operable to transmit the requests in response to a predefined event.

8. The system of claim 1, wherein each console interface is further operable to transmit the console information associated with the respective console, in real-time.

9. The system of claim 1, wherein the memory module comprises a buffer.

10. The system of claim 1, wherein the console server is located in a remote location from at least one of the plurality of computing devices, and the console server is coupled with the plurality of computing devices over a communication network.

11. The system of claim 1, wherein the console server is operable to present the console information regarding each of the plurality of computing devices, at a graphical user interface, during a single communication session.

12. The system of claim 1, wherein the console server comprises a network interface card, and the plurality of computing devices comprise server processing cards.

13. The system of claim 1, further comprising a backup console server operable to monitor communications with the console server, and wherein the backup console server is operable to assume responsibilities of the console server if a communication failure with the console server is detected.

14. A server chassis, comprising:
a plurality of server processing cards, each server processing card including a respective console and a respective console interface;
each console interface being operable to transmit console information associated with the respective console;
a console server coupled for communication with the plurality of server processing cards; and
the console server including a memory module operable to receive and store at least a portion of a console information.

15. The server chassis of claim 14, further comprising a communication bus forming the communication coupling between the console server and the plurality of web server processing cards.

16. The server chassis of claim 15, wherein the communication bus comprises an RS-485 communication bus.

17. A method for storing console information associated with a plurality of computing devices, each computing device having a respective console, and a respective console interface, comprising:
coupling a console server for communication with a plurality of computing devices, the console server including a memory module;
transmitting console information associated with the respective console, from the respective console interface;
receiving the console information at the memory module; and
storing, at least temporarily, the console information at the memory module.

18. The method of claim 17, further comprising transmitting the console information to the console server, periodically, from the respective console interface.

19. The method of claim 17, further comprising transmitting requests to the plurality of computing devices to transfer at least a portion of the console information to the console server, the requests being transmitted from the console server.

20. The method of claim 17, further comprising presenting the console information regarding each of the plurality of computing devices, at a graphical user interface, during a single communication session, the graphical user interface being coupled with the console server.

21. The method of claim 17, further comprising:
monitoring communications between the console server and a backup console server; and
transferring responsibilities of the console server to the backup console server if a communication failure with the console server is detected.

22. Logic encoded in media for storing console information associated with a plurality of computing devices, each computing device having a respective console, and a respective console interface, the logic being operable to perform the following steps:
couple a console server for communication with the plurality of computing devices, the console server including a memory module;
transmit console information associated with the respective console, from the respective console interface;
receive the console information at the memory module; and
store, at least temporarily, the console information at the memory module.

23. The logic encoded in media of claim 22, wherein the logic is further operable to transmit the console information to the console server, periodically, from the console interface.

24. The logic encoded in media of claim 22, wherein the logic is further operable to transmit requests from the console server to the plurality of computing devices to transfer at least a portion of the console information to the console server.

25. The logic encoded in media of claim 22, wherein the logic is further operable to present the console information regarding each of the plurality of computing devices at a graphical user interface, during a single communication session, the graphical user interface being coupled with the console server.

26. The logic encoded in media of claim 22, wherein the logic is further operable to:
monitor communications between the console server and a backup console server; and
transfer responsibility from the console server to the backup console server if a communication failure with the console server is detected.

27. A system for storing console information associated with a plurality of computing devices, each computing device having a respective console, and a respective console interface, comprising:
means for coupling a console server for communication with the plurality of computing devices, console server including a memory module;
means for transmitting console information associated with the respective console, from the respective console interface;
means for receiving the console information at the memory module; and
means for storing, at least temporarily, a console information at the memory module.

28. The system of claim 27, further comprising means for transmitting the console information to the console server, periodically, from the respective console interface.

29. The system of claim 27, further comprising means for transmitting requests from the console server to the plurality of computing devices, to transfer at least a portion of the console information to the console server.

30. The system of claim 27, further comprising means for presenting the console information regarding each of the plurality of computing devices, at a graphical user interface, during a single communication session, the graphical user interface being coupled with the console server.

31. The system of claim 27, further comprising:
means for monitoring communications between the console server and a backup console server; and
means for transferring responsibilities of the console server to the backup up console server if a communication failure with the console server is detected.

32. A system, comprising:
a first server chassis including a first plurality of server processing cards and a first link board;
a second server chassis including a second plurality of server processing cards and a second link board;
the first and second link boards being operable to collect console information regarding the first plurality of server processing cards and the second plurality of server processing cards, respectively; and
wherein the first and second link boards are coupled for communication of the console information between the first and second link boards.

33. The system of claim 32, further comprising:
at least a third server chassis including a third plurality of server processing cards and a third link board;
a first communication link coupling the first link board with the second link board such that the console information regarding the first plurality of server processing cards may be directly communicated from the first link board to the second link board; and
a second communication link coupling the first link board with the third link board such that the console information regarding the first plurality of server processing cards may be communicated directly to the third link board.

34. The system of claim 33, wherein the first and second communication links comprise RS-485 communication links.

35. The system of claim 32, further comprising:
at least a third server chassis including a third plurality of server processing cards and a third link board; and
wherein the first, second and third link boards are each coupled with at least two communication links such that console information may be communicated from any one of the first, second or third link boards along at least two separate communication paths.
